(19) United States
(12) Patent Application Publication
(10) Pub. No.: US 2024/0292459 A1
(43) Pub. Date: Aug. 29, 2024

(54) DEVICES AND METHODS FOR COORDINATED TRANSMISSION IN A WIRELESS NETWORK

(71) Applicant: HUAWEI TECHNOLOGIES CO., LTD., Shenzhen (CN)

(72) Inventors: Genadiy TSODIK, Boulogne Billancourt (FR); Shimon SHILO, Boulogne Billancourt (FR); Oded REDLICH, Boulogne Billancourt (FR); Arik KLEIN, Boulogne Billancourt (FR); Doron EZRI, Boulogne Billancourt (FR)

(21) Appl. No.: 18/656,786

(22) Filed: May 7, 2024

Related U.S. Application Data
(63) Continuation of application No. PCT/EP2021/080915, filed on Nov. 8, 2021.

(51) Int. Cl. H04W 74/0816; H04L 1/1607

(52) U.S. Cl. CPC H04W 74/0816; H04L 1/1614

(57) ABSTRACT

A sharing AP (110) is configured to share a transmission opportunity, TXOP, with a shared AP (120, 130) within a Multi-AP set for participating in a coordinated transmission, wherein the sharing AP (110) is configured to communicate with one or more stations (115a-c) associated with the sharing AP via one or more spatial streams and the shared AP is configured to communicate with one or more stations (125a,b) associated with the shared AP via one or more further spatial streams.

### CROSS-REFERENCE TO RELATED APPLICATIONS

This application is a continuation of International Application No. PCT/EP2021/080915, filed on Nov. 8, 2021, the disclosure of which is hereby incorporated by reference in its entirety.

### TECHNICAL FIELD

The present disclosure relates to wireless communications. More specifically, the present disclosure relates to devices and methods for coordinated transmission in a wireless communication network.

### BACKGROUND

IEEE 802.11-based WLANs have become popular at an unprecedented rate. 802.11be introduces a Multi AP (M-AP) coordinated transmission, where a group of access points (APs) may initiate concurrent frame exchange within a limited time period and one or more APs of the group of APs may share one or more transmission opportunities (TXOPs). The group of APs that have decided to cooperate and perform coordinated transmissions is called a M-AP set.

### SUMMARY

It is an objective to provide improved devices and methods for AP coordinated transmission in a wireless communication network, in particular an IEEE 802.11 based wireless communication network.

The foregoing and other objectives are achieved by the subject matter of the independent claims. Further implementation forms are apparent from the dependent claims, the description and the figures.

According to a first aspect a sharing access point, AP, is provided, wherein the sharing AP is configured to share at least a portion of a transmission opportunity, TXOP, with at least one shared AP under the same coordination agreement within a Multi-AP set (also referred to as M-AP set) for participating in a coordinated beamforming (CoBF) transmission scheme. The sharing AP is configured to communicate with one or more stations associated with the sharing AP via one or more spatial streams and the shared AP is configured to communicate with one or more stations associated with the shared AP via one or more further spatial streams. The sharing AP comprises a communication interface configured to transmit (and receive) a frame to the at least one shared AP, wherein the frame comprises:
a common block comprising one or more parameters for the at least one shared AP that may participate in the coordinated AP transmission using the CoBF transmission scheme;
one or more station information blocks, wherein each station information block includes one or more parameters of the respective station associated with the sharing AP, is identified within the station information block and to be included in the CoBF transmission scheme; and
a shared AP information block for the at least one shared AP that may participate in the coordinated AP transmission using the CoBF transmission scheme, comprising, at least, information about a number (herein referred to as Nss) of the one or more further spatial streams (or spatial stream indices) assigned to the at least one shared AP.

In a further possible implementation form, the sharing AP further comprises a processing circuitry configured to assign the one or more spatial streams, e.g. spatial stream indices to the one or more stations associated with the sharing AP.

In a further possible implementation form, the processing circuitry is further configured to assign the one or more further spatial streams, e.g. spatial stream indices to the at least one shared AP.

In a further possible implementation form, the common block of the frame comprises information about a number of the station information blocks contained within the frame and related to the one or more stations associated with the sharing AP that will participate in the CoBF AP transmission.

In a further possible implementation form, the common block of the frame comprises information about a number of the shared AP information blocks contained within the frame and related to the shared AP that should participate in the CoBF AP transmission.

In a further possible implementation form, the common block of the frame further comprises a Multi-AP set identifier.

In a further possible implementation form, the common block of the frame further comprises a coordination agreement identifier within the Multi-AP set, wherein the coordination agreement identifier identifies one coordination agreement of a plurality of coordination agreements within the Multi-AP set and wherein the sharing AP and the shared AP both operate under the coordination agreement identified by the coordination agreement identifier within the Multi-AP set.

In a further possible implementation form, the common block of the frame further comprises a response type indicator indicative of a response type to be used by the shared AP for responding to the soliciting frame.

In a further possible implementation form, the one or more parameters included in the respective station information block comprise information about a number of the spatial streams of the one or more spatial streams assigned to the respective station associated with the sharing AP.

In a further possible implementation form, the one or more parameters included in the respective station information block comprise an identifier of the respective station associated with the sharing AP recognizable by the at least one shared AP operating under the same coordination agreement within the M-AP set.

In a further possible implementation form, the one or more parameters included in the respective station information block comprise information about a first, i.e. the smallest spatial stream index (herein referred to as Start SS index) of the spatial streams of the one or more spatial streams assigned to the respective station associated with the sharing AP.

In a further possible implementation form, the one or more parameters included in the respective station information block comprise nulling information, e.g. a nulling bitmap for enabling the shared AP to determine whether nulling of a transmission signal towards the respective station associated with the sharing AP and to be included in the CoBF transmission scheme is required for the coordinated CoBF transmission scheme.

In a further possible implementation form, the shared AP information block further comprises an identifier of the shared AP within the Multi-AP set.

In a further possible implementation form, the shared AP information block further comprises information about a first, i.e. the smallest spatial stream index (herein referred to as Start SS index) of the further set of spatial streams assigned to the shared AP.

In a further possible implementation form, the shared AP information block further comprises one or more further station information blocks, wherein each further station information block includes one or more parameters of the respective station associated with the shared AP, identified within the further station information block and to be included in the CoBF transmission scheme.

Each of the one or more further station information blocks may have the same format (i.e. the same length as well as the same subfields) as each of the one or more station information blocks.

Thus, in a further possible implementation form, the shared AP information block further comprises information about a number of the further station information blocks included in the shared AP information block.

In a further possible implementation form, the one or more parameters included in the respective further station information block comprise information about a number of spatial streams (herein referred to as Nss) of the one or more further spatial streams assigned to the respective station associated with the shared AP.

In a further possible implementation form, the one or more parameters included in the respective further station information block comprise an identifier of the respective station associated with the shared AP recognizable by the at least one shared AP or Sharing AP operating under the same coordination agreement within the M-AP set.

In a further possible implementation form, the one or more parameters included in the respective further station information block comprise information about a first, i.e. the smallest spatial stream index (herein referred to as Start SS index) of the spatial streams of the one or more further spatial streams of the shared AP assigned to the respective station associated with the shared AP.

In a further possible implementation form, the one or more parameters included in the respective further station information block comprise nulling information, e.g. a nulling bitmap for enabling a further shared AP or the sharing AP to determine whether nulling of the respective station associated with the shared AP is required.

In a further possible implementation form, the communication interface is configured to receive at least one response frame from the at least one shared AP, wherein the response frame comprises information about one or more updated parameters, for instance, an updated number of the one or more further spatial streams of the shared AP, i.e. that are actually used by the shared AP.

In a further possible implementation form, the communication interface is configured to transmit the frame at least to the shared AP, in response to receiving the response frame from at least the shared AP.

According to a second aspect, a method is provided for sharing at least a portion of a transmission opportunity, TXOP, by a sharing AP with at least one shared AP under the same coordination agreement within a Multi-AP set for participating in a coordinated beamforming (CoBF) transmission scheme. The sharing AP is configured to communicate with one or more stations associated with the sharing AP via one or more spatial streams and the shared AP is configured to communicate with one or more stations associated with the shared AP via one or more further spatial streams. The method comprises the step of transmitting (or receiving) a frame to the at least one shared AP that may participate in the coordinated AP transmission using the CoBF transmission scheme, wherein the frame comprises:
a common block comprising one or more parameters for the at least one shared AP that may participate in the coordinated AP transmission using the CoBF transmission scheme;
one or more station information blocks, wherein each station information block includes one or more parameters of the respective station associated with the sharing AP indicated within the station information block and to be included in the CoBF transmission scheme; and
a shared AP information block for the at least one shared AP that may participate in the coordinated AP transmission using the CoBF transmission scheme, comprising, at least, information about a number of the one or more further spatial streams assigned to the at least one shared AP.

In a further possible implementation form, the method further comprises receiving a response frame from the at least one shared AP, in response to transmitting the frame to the at least one shared AP.

In a further possible implementation form, the method further comprises transmitting the frame to the at least one shared AP, in response to receiving a response frame from the at least one shared AP.

In a further possible implementation form, the response frame comprises, at least, information about an updated number of the one or more further spatial streams of the at least one shared AP, i.e. that are actually used by the shared AP.

In a further possible implementation form, the response frame comprises one or more station information blocks, wherein each station information block of the response frame comprises nulling information, e.g. a nulling bitmap for enabling the sharing AP or a further shared AP to determine whether nulling of a transmission signal towards the respective station associated with the shared AP and to be included in the CoBF AP transmission is required for the CoBF AP transmission.

The method according to the second aspect of the present disclosure can be performed by the sharing AP according to the first aspect of the present disclosure. Thus, further features of the method according to the second aspect of the present disclosure result directly from the functionality of the sharing AP according to the first aspect of the present disclosure as well as its different implementation forms described above and below.

According to a third aspect a shared access point, AP, is provided, wherein the shared AP is configured to participate in one or more coordinated CoBF transmissions making use of at least a portion of a transmission opportunity, TXOP, shared by a sharing AP under the same coordination agreement within a Multi-AP set. The sharing AP is configured to communicate with one or more stations associated with the sharing AP via one or more spatial streams and the shared AP is configured to communicate with one or more stations associated with the shared AP via one or more further spatial streams. The shared AP comprises a communication interface configured to receive a frame from the sharing AP, wherein the frame comprises:
a common block comprising one or more parameters for the shared AP that may participate in the coordinated AP transmission using the CoBF transmission scheme;
one or more station information blocks, wherein each station information block includes one or more parameters of the respective station associated with the sharing AP identified within the station information block and to be included in the coordinated AP transmission; and
a shared AP information block for each of the shared APs that are involved in the coordinated transmission, comprising, at least, information about a number of the one or more further spatial streams assigned to the shared AP.

In a further possible implementation form, the communication interface is further configured to transmit, in response to receiving the frame from the sharing AP, a response frame to the sharing AP, wherein the response frame comprises, at least, information about an updated number of the one or more further spatial streams of the shared AP, i.e. that are actually used by the shared AP.

In a further possible implementation form, the response frame comprises a Multi-AP set identifier.

In a further possible implementation form, the response frame comprises a coordination agreement identifier within the Multi-AP set, wherein the coordination agreement identifier identifies one coordination agreement of a plurality of coordination agreements within the Multi-AP set and wherein the sharing AP and the shared AP both operate under the coordination agreement identified by the coordination agreement identifier within the Multi-AP set.

In a further possible implementation form, the response frame comprises one or more station information blocks, wherein each station information block includes one or more parameters of the respective station associated with the shared AP identified within the station information block and to be included in the CoBF AP transmission.

In a further possible implementation form, the response frame comprises information about a number of the station information blocks of the response frame.

In a further possible implementation form, the one or more parameters included in the respective station information block of the response frame of the response frame comprise information about a number of spatial streams of the one or more further spatial streams assigned to the respective station associated with the shared AP.

In a further possible implementation form, the one or more parameters included in the respective station information block of the response frame comprise an identifier of the respective station associated with the shared AP recognizable by the sharing AP and/or a further shared AP operating under the same coordination agreement within the M-AP set.

In a further possible implementation form, the one or more parameters included in the respective station information block of the response frame comprise information about a first, i.e. the smallest spatial stream index of the spatial streams of the one or more further spatial streams assigned to the shared AP and re-assigned by the shared AP to the respective station associated with the shared AP.

In a further possible implementation form, the one or more parameters included in the respective station information block of the response frame comprise nulling information, e.g. a nulling bitmap for enabling the sharing AP or a further shared AP to determine whether nulling of a transmission signal towards the respective station associated with the shared AP and to be included in the CoBF AP transmission is required for the CoBF AP transmission.

According to a fourth aspect a method is provided for participating by a shared access point, AP, in one or more coordinated transmissions making use of at least a portion of a transmission opportunity, TXOP, shared by a sharing AP under the same coordination agreement within a Multi-AP set. The sharing AP is configured to communicate with one or more stations associated with the sharing AP via one or more spatial streams and the shared AP is configured to communicate with one or more stations associated with the shared AP via one or more further spatial streams. The method comprises the step of receiving a frame from the sharing AP, wherein the frame comprises:
a common block comprising one or more parameters for the shared APs that may participate in the coordinated AP transmission using the CoBF transmission scheme;
one or more station information blocks, wherein each station information block includes one or more parameters of the respective station associated with the sharing AP identified within the station information block and to be included in the coordinated CoBF AP transmission; and
a shared AP information block comprising, at least, information about a number of the one or more further spatial streams assigned to the shared AP.

In a further possible implementation form, the method further comprises transmitting a response frame to the sharing AP, wherein the response frame comprises, at least, information about an updated number of the one or more further spatial streams of the shared AP, i.e. that are actually used by the shared AP.

In a further possible implementation form, the method comprises transmitting the response frame to the sharing AP, in response to receiving the frame from the sharing AP.

In a further possible implementation form, the method comprises receiving the frame from the sharing AP, in response to transmitting the response frame to the sharing AP.

The method according to the fourth aspect of the present disclosure can be performed by the shared AP according to the third aspect of the present disclosure. Thus, further features of the method according to the fourth aspect of the present disclosure result directly from the functionality of the shared AP according to the third aspect of the present disclosure as well as its different implementation forms described above and below.

According to a fifth aspect a computer program product is provided, comprising a computer-readable storage medium for storing program code which causes a computer or a processor to perform the method according to the second aspect or the method according to the fourth aspect, when the program code is executed by the computer or the processor.

Details of one or more embodiments are set forth in the accompanying drawings and the description below. Other features, objects, and advantages will be apparent from the description, drawings, and claims.

### BRIEF DESCRIPTION OF THE DRAWINGS

In the following, embodiments of the present disclosure are described in more detail with reference to the attached figures and drawings, in which:

FIG. 1 shows an exemplary wireless communication network including a sharing AP and a shared AP for CoBF transmission according to an embodiment;

FIG. 2 illustrates interference in an exemplary wireless communication network;

FIG. 3 shows a schematic diagram illustrating the frame types to be exchanged in a wireless communication network for coordinating the parameters required from each AP to enable the Co-BF transmission;

FIG. 4 shows a schematic diagram illustrating a frame exchange in a wireless communication network according to an embodiment;

FIG. 5 shows a schematic diagram illustrating a format of a frame transmitted by a sharing AP according to an embodiment;

FIG. 6 shows a schematic diagram illustrating in more detail the format of a shared AP information field of the frame of FIG. 5;

FIG. 7 shows a schematic diagram illustrating in more detail the format of a station information field of the frame of FIG. 5;

FIG. 8 shows a schematic diagram illustrating in more detail a nulling bitmap of the station information field of FIG. 7;

FIG. 9 illustrates nulling based on a nulling bitmap in an exemplary wireless communication network according to an embodiment;

FIG. 10 shows a schematic diagram illustrating a response frame transmitted by a shared AP according to an embodiment;

FIG. 11 is a flow diagram illustrating a method of operating a sharing AP according to an embodiment; and

FIG. 12 is a flow diagram illustrating a method of operating a shared AP according to an embodiment.

In the following, identical reference signs refer to identical or at least functionally equivalent features.

### DETAILED DESCRIPTION OF THE EMBODIMENTS

In the following description, reference is made to the accompanying figures, which form part of the disclosure, and which show, by way of illustration, specific aspects of embodiments of the present disclosure or specific aspects in which embodiments of the present disclosure may be used. It is understood that embodiments of the present disclosure may be used in other aspects and comprise structural or logical changes not depicted in the figures. The following detailed description, therefore, is not to be taken in a limiting sense, and the scope of the present disclosure is defined by the appended claims.

For instance, it is to be understood that a disclosure in connection with a described method may also hold true for a corresponding device or system configured to perform the method and vice versa. For example, if one or a plurality of specific method steps are described, a corresponding device may include one or a plurality of units, e.g. functional units, to perform the described one or plurality of method steps (e.g. one unit performing the one or plurality of steps, or a plurality of units each performing one or more of the plurality of steps), even if such one or more units are not explicitly described or illustrated in the figures. On the other hand, for example, if a specific apparatus is described based on one or a plurality of units, e.g. functional units, a corresponding method may include one step to perform the functionality of the one or plurality of units (e.g. one step performing the functionality of the one or plurality of units, or a plurality of steps each performing the functionality of one or more of the plurality of units), even if such one or plurality of steps are not explicitly described or illustrated in the figures. Further, it is understood that the features of the various exemplary embodiments and/or aspects described herein may be combined with each other, unless specifically noted otherwise.

Coordinated BF (CoBF) is a coordination scheme proposed for next generation Wi-Fi for simultaneous data transmission by several APs. This coordination scheme assumes that each participating AP has the capability to precode its transmitted signal such that mutual interference between this AP and the STAs of the OBSS (Overlapping BSS) during coordinated transmission is minimized (also referred to as nulling). Similarly to all other coordination schemes, CoBF is initialized by a sharing AP that proposes other APs (referred to as shared APs) to transmit simultaneously. The proposed resources in this case are spatial streams, where the sharing AP assigns a specific respective number of spatial streams to each shared AP. CoBF may make use of an additional sounding procedure for estimating the channels between the APs and STAs, which, however, is not addressed in further detail herein. Based on the estimated channels the APs may construct precoder matrices for generating beams and nulls toward STAs that participate in the current CoBF transmissions.

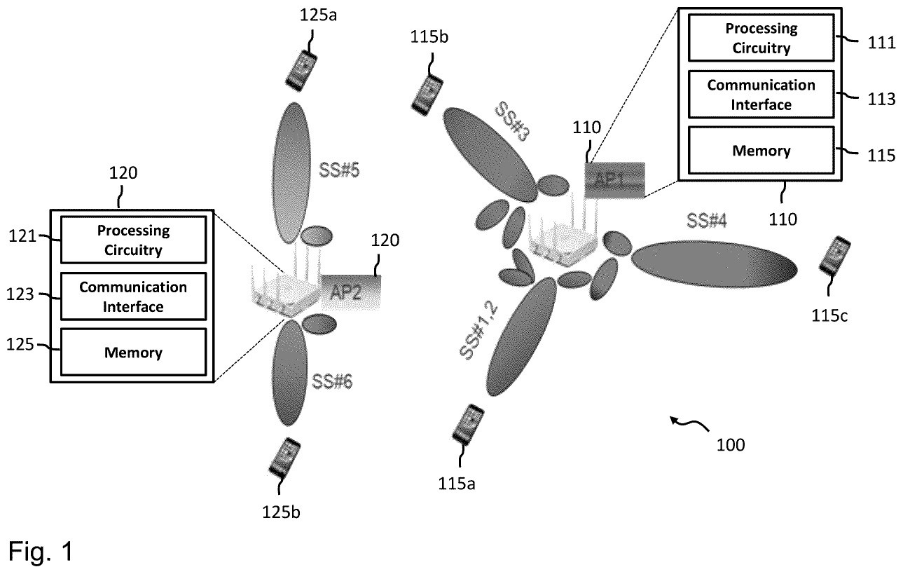

FIG. 1 shows an exemplary wireless communication network 100 including a sharing AP 110 and a shared AP 120 for CoBF transmission according to an embodiment. The sharing AP 110 is configured to share at least a portion of a transmission opportunity, TXOP, with the shared AP 120 under the same coordination agreement within a Multi-AP set (also referred to as M-AP set) for participating in a coordinated beamforming (CoBF) transmission. In the exemplary embodiment shown in FIG. 1, the sharing AP 110 is configured to communicate with its associated stations 115a, 115b and 115c, while the shared AP 120 is configured to communicate with its associated stations 125a, 125b.

As illustrated in FIG. 1, the sharing AP 110 comprises a processing circuitry 111 and a communication interface 113, in particular a wireless communication interface 113 in accordance with the IEEE 802.11 framework of standards. The processing circuitry 111 may be implemented in hardware and/or software and may comprise digital circuitry, or both analog and digital circuitry. Digital circuitry may comprise components such as application-specific integrated circuits (ASICs), field-programmable arrays (FPGAs), digital signal processors (DSPs), or general-purpose processors. The sharing AP 110 may further comprise a memory 115 configured to store executable program code which, when executed by the processing circuitry 111, causes the sharing AP 110 to perform the functions and methods described herein.

Likewise, the shared AP 120 illustrated in FIG. 1 comprises a processing circuitry 121 and a communication interface 123, in particular a wireless communication interface 123 in accordance with the IEEE 802.11 framework of standards. The processing circuitry 121 may be implemented in hardware and/or software and may comprise digital circuitry, or both analog and digital circuitry. Digital circuitry may comprise components such as application-specific integrated circuits (ASICs), field-programmable arrays (FPGAs), digital signal processors (DSPs), or general-purpose processors. The shared AP 120 may further comprise a memory 125 configured to store executable program code which, when executed by the processing circuitry 121, causes the shared AP 120 to perform the functions and methods described herein.

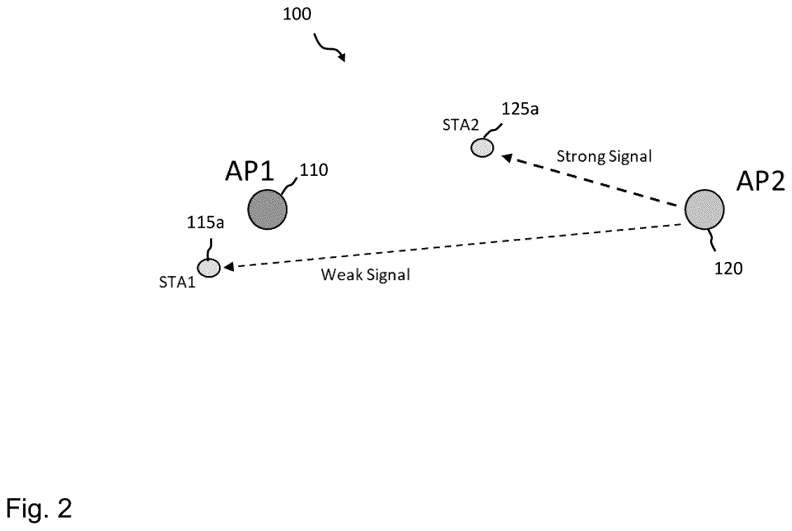

Null creation is a challenging problem which requires accurate information about several parameters at the transmitter side, such as the exact channel between the interfering transmitter and the receiver, number of spatial streams and specific indices of spatial streams, assigned to the desired STA. Each transmitter that creates a null towards a specific STA may use a number of degree of freedoms equal to the number of spatial streams assigned to this STA. For the example shown in FIG. 2, if the AP1 110 assigns two spatial streams to its associated STA1 115a, the AP2 120 may use 2 degrees of freedom to create a null towards the STA1 115a. Thus, operating a CoBF scheme requires both signaling overhead to obtain the information mentioned above and also a commitment from the AP to use degrees of freedom to create the nulls towards other STAs.

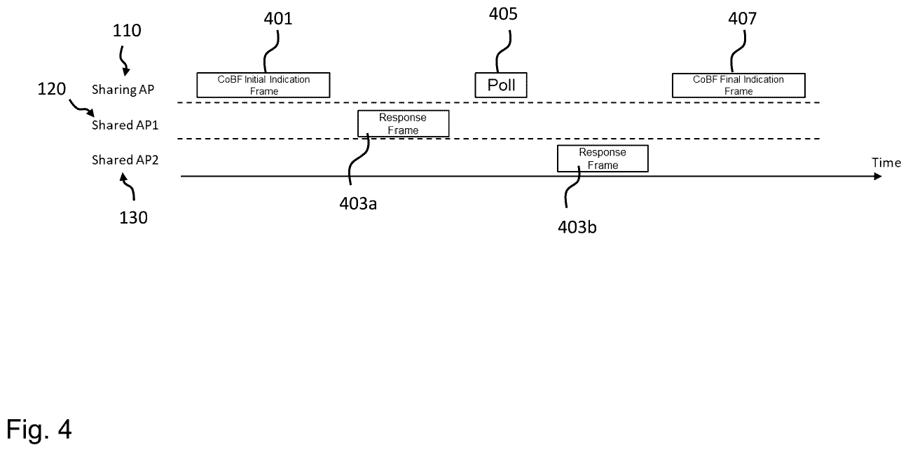

Moreover, according to embodiments disclosed herein, different levels of nulling may be used for a CoBF scheme. In a first embodiment (referred to herein as partial nulling CoBF) only the shared APs 120, 130 (see also FIG. 4) are requested to precode the transmission signals to minimize interference to STAs associated with the sharing AP 110. In other words, the sharing AP 110 does not need to null its transmission signal towards the OBSS STAs, such as the stations 125a,b associated with the shared AP 120 in the exemplary wireless network 100 shown in FIG. 1. For this embodiment, the shared APs 120, 130 need to know only the exact assignment of spatial streams to all the STAs associated with the sharing AP 110 that participate in the current transmission.

In a second embodiment (referred to herein as full nulling CoBF) both the sharing AP 110 and the shared APs 120, 130 are requested to precode the transmission signals to minimize interference to participating STAs associated with other APs. For this embodiment all the participating APs need to know the exact assignment of spatial streams to all the participating STA from all the BSSs.

It may be assumed that in some cases nulling is not required from a specific AP towards a specific STA (for example when a STA is located far from this AP and the signal strength is too low at the receiver). For example, in the example shown in FIG. 2, STA1 115a is located far from OBSS AP2 120 and faces a very weak signal. Thus, if AP1 includes STA1 115a in the CoBF transmission, the AP2 120 may not be required to create a null towards it.

In order to support, for instance, two nulling levels as described above, the sharing AP 120 according to an embodiment is configured to indicate the assignment of spatial streams to its associated STAs 115a-c and indices of the spatial streams allocated to each Shared AP 120, 130 (see also FIG. 4) that will participate in an upcoming CoBF transmission. For the “full nulling CoBF” embodiment, the shared APs 120, 130 according to an embodiment are configured to indicate the exact assignment of spatial streams to their STAs 125a,b (within the range suggested by the sharing AP 110). In order to exchange this information within the wireless communication network 100 shown in FIG. 1, embodiments disclosed herein provide a special protocol (designed for CoBF) for the exchange of frames between the sharing AP 110 and the shared APs 120, 130, as will be described in more detail in the following under further reference to FIG. 4. Thus, embodiments disclosed herein provide information exchange frames that ensure that all the APs have the ability to successfully inform all the other APs regarding all the required parameters for CoBF.

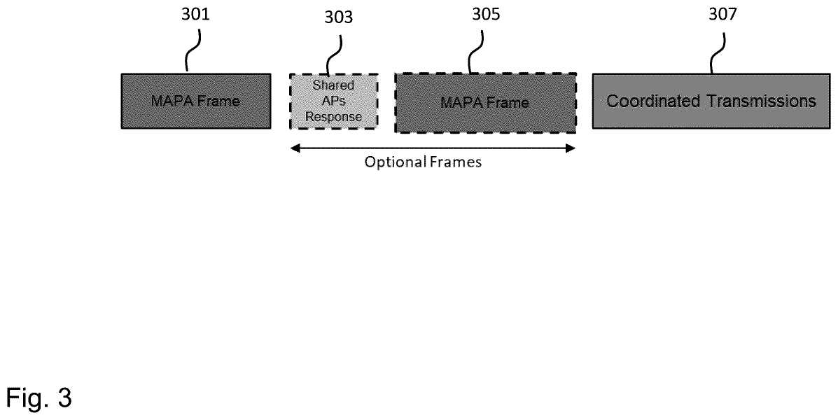

FIG. 3 shows a schematic diagram illustrating stages of the coordination between a sharing AP 110 and shared AP(s) 120, 130 in a wireless communication network prior to the coordinated transmission stage. FIG. 3 shows one or more Multi-AP announcement (MAPA) frames 301, 305 and possibly a response 303 from each of the shared AP(s) operating under the same coordination agreement. The frame exchange shown in FIG. 4 allows the sharing AP 110 to indicate all the shared APs 120, 130 regarding the current coordinated transmission(s) 307 and request the response 303, which may include an approval/disapproval as well as one or more parameters regarding the shared AP 120, 130 and its associated STAs that are going to participate in the M-AP coordinated transmission. The MAPA frame(s) 301, 305 may include special reserved field/elements that may carry information that is relevant only for a specific coordination scheme.

In an embodiment, the processing circuitry 113 of the sharing AP 110 may be configured to assign the one or more spatial streams, e.g. spatial stream indices to the one or more stations associated with the sharing AP 110. For instance, in the exemplary embodiment shown in FIG. 1, the processing circuitry 111 of the sharing AP 110 may be configured to assign the spatial streams SS #1 and SS #2 to the station 115a, the spatial stream SS #3 to the station 115b and the spatial stream SS #4 to the station 115c. In a further embodiment, the processing circuitry 113 of the sharing AP 110 is further configured to assign the one or more further spatial streams, e.g. spatial stream indices to the at least one shared AP 120. For instance, in the exemplary embodiment shown in FIG. 1, the processing circuitry 121 of the shared AP 120 may be configured to assign the spatial stream SS #5 to the station 125a and the spatial stream SS #6 to the station 125b.

The frame exchange protocol of FIG. 4, as implemented by the sharing AP 110 and the shared APs 120, 130 according to an embodiment, allows the sharing AP 110 and the shared APs 120, 130 to exchange the necessary CoBF information/parameters, in particular specific spatial streams assignments per STAs 115a-c, 125a,b. The frame exchange protocol of FIG. 4, as implemented by the sharing AP 110 and the shared APs 120, 130 according to an embodiment, may contain three phases. In a first phase (Initial indication transmitted by sharing AP 110) the sharing AP 110 shall provide information about the spatial stream indices assignment to each of the shared APs 120, 130 and optionally information about the STAs 115a-c associated with the sharing AP 110. In a second phase (Response indication transmitted by shared AP 120, and by shared AP 130, in response to a poll frame 405) if they are willing to participate in the coordinated transmission, the shared AP(s) 120, 130 shall provide information about the number of spatial streams (or indices) to be used as well as information on the STAs 125a,b associated with the shared AP(s) 120, 130 if full nulling CoBF is applied. In a third final phase (final indication transmitted by the sharing AP 110, if there was a required response) the sharing AP 110 may provide information about the final CoBF configuration including all the parameters as indicated by the shared AP(s) 120, 130.

As already described above under reference to FIG. 4, the communication interface 113 of the sharing AP 110 is configured to transmit a frame 401, 407, namely the CoBF Initial Indication Frame 401 transmitted by the sharing AP 110 at the beginning of the frame exchange with the shared APs 120, 130 or the CoBF Final Indication Frame 407 transmitted by the sharing AP 110 at the end of the frame exchange illustrated in FIG. 4. In other words, according to embodiments disclosed herein, the Initial Indication Frame 401 and the Final Indication Frame 407 may have the same general format. In an embodiment, the Initial Indication Frame 401 and the Final Indication Frame 407 may include components of respective larger frames or be stand-alone frames.

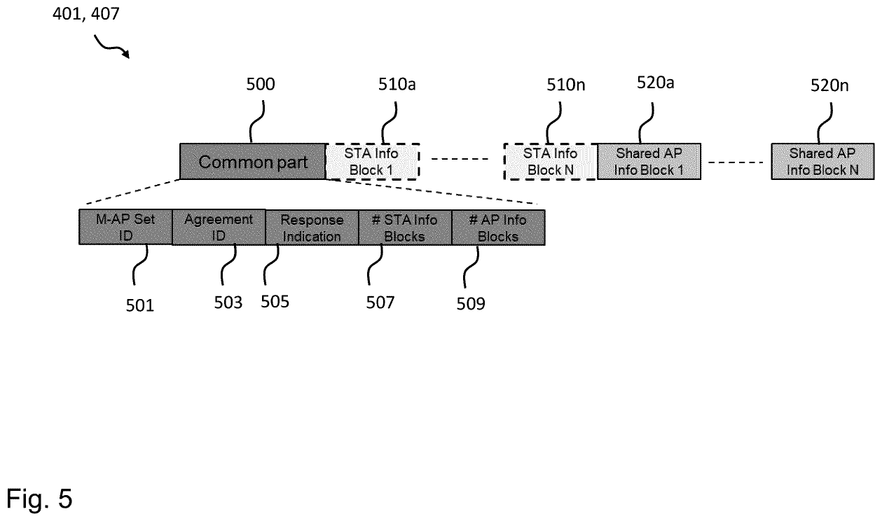

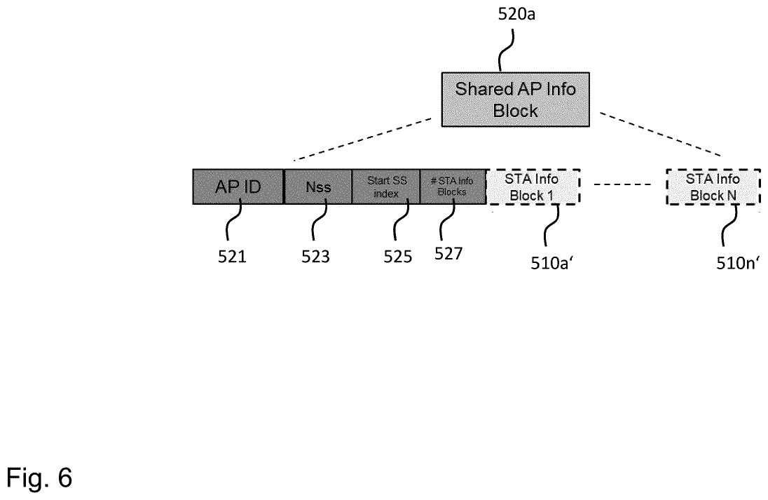

More specifically, as shown in FIG. 5, the frame 401, 407 comprises a common block (or common part) 500 comprising one or more parameters for the shared APs 120, 130 that may participate in the coordinated AP transmission using the CoBF transmission scheme. Moreover, the frame 401, 407 comprises a plurality of station information blocks 510a-n, wherein each station information block 510a-n includes one or more parameters of the respective station 115a-c associated with the sharing AP 110 identified within the station information block 510a-n and to be included in the Co-BF transmission scheme. For the example shown in FIG. 1, the frame 401, 407 may comprise three station information blocks 510a-c, wherein each of the three station information blocks 510a-c includes one or more parameters of the respective station 115a-c associated with the sharing AP 110 and that will participate in the Co-BF transmission. Furthermore, the frame 401, 407 comprises a shared AP information block 520a-n for the at least one shared AP(s) 120, 130 that may participate in the coordinated AP transmission using the Co-BF transmission scheme, wherein each shared AP information block 520a-n comprises, at least, information 523 about a number (herein referred to as Nss) of the one or more further spatial streams (or spatial stream indices) assigned to the shared AP that is identified by an AP ID identifier 521, as illustrated in FIG. 6. For the example shown in FIG. 1, the frame 401, 407 comprises a shared AP information block 520a for the shared AP 120, wherein the shared AP information block 520a comprises the information 523 that two spatial streams (namely SS #5 and SS #6) are assigned to the shared AP 120.

Further to the information content of the frame 401, 407 described above, in an embodiment, the common block 500 of the frame 410, 407 may further comprise information 507 (referred to as “#STA Info Blocks” in FIG. 5) about the number of the station information blocks 510a-n contained within the frame 401, 407 and related to the stations 115a-c associated with the sharing AP 110 that will participate in the CoBF AP transmission. In an embodiment, the common block 500 of the frame 401, 407 may further comprise information 509 (referred to as “#AP Info Blocks” in FIG. 5) about the number of the shared AP information blocks 520a-n contained within the frame 401, 407 and related to the shared AP 120, 130 that should participate in the CoBF AP transmission. In an embodiment, the common block 500 of the frame 401, 407 may further comprise a Multi-AP set identifier 501 indicative of the Multi-AP set including the sharing AP 110 and the shared AP(s) 120, 130. In an embodiment, the common block 500 of the frame 401, 407 may further comprise a coordination agreement identifier 503 within the Multi-AP set. The coordination agreement identifier 503 identifies one coordination agreement of a plurality of coordination agreements within the Multi-AP set (as uniquely identified by the M-AP Set ID 501), wherein the sharing AP 110 and the shared AP(s) 120, 130 both operate under the coordination agreement identified by the coordination agreement identifier 503 within the Multi-AP set. In an embodiment, the common block 500 of the frame 401, 407 may further comprise a response type indicator 505 indicative of a response type to be used by the shared AP 120, 130 for responding to the soliciting frame 401, 407, such as a parallel response or a sequential response.

FIG. 6 shows a schematic diagram illustrating in more detail one of the shared AP information blocks 520a of the frame 401, 407 shown in FIG. 5. As will be appreciated, any other shared AP information blocks 520b-n of the frame 401, 407 shown in FIG. 5 may have the same structure as the shared AP information block 520a shown in FIG. 5.

Further to the information 523 (“Nss”) regarding the number of spatial streams assigned to the shared AP identified by the AP ID 521 and the initial index assigned by the sharing AP 110 to the respective shared AP identified by the AP ID 521, the shared AP information block 520a of the frame 401, 407 may include some common information as well as a plurality of further station information blocks 510a′-n′. Each further station information block 510a′-n′ includes one or more parameters of the respective station associated with the respective shared AP, identified within the station information block and to be included in the CoBF transmission scheme. For instance, for the exemplary scenario shown in FIG. 1, the shared AP information block 520a of the frame 401, 407 may comprise two further station information blocks, wherein one of the two further station information blocks includes one or more parameters of the station 125a associated with the shared AP 120, while the other of the two further station information blocks includes one or more parameters of the station 125b associated with the shared AP 120. In an embodiment, the further station information blocks 510a′-n′ may have the same format/structure as the station information blocks 510a-n described above. Thus, in the exemplary embodiment of FIG. 1, the two station information blocks for the stations 125a,b associated with the shared AP 120 may have the same format/structure as the three station information blocks (already described above in the context of FIG. 5) for the stations 115a-c associated with the sharing AP 110. As illustrated in FIG. 6 and already mentioned above, in an embodiment, the common information of the shared AP information block 520a of the frame 401, 407 may include a unique identifier (“AP ID”) 521 of the respective shared AP 120, 130 within the Multi-AP Set, an index (“Start SS index”) 525 of the first spatial stream assigned to the respective shared AP 120 (which allows to obtain specific SS indices assigned to the respective shared AP 120) and/or information (“#STA info blocks”) 527 about the number of further station information blocks 510a′-n′ of the respective shared AP info block 520a. In an embodiment, the information (“#STA info blocks”) 527 may indicate “none” or “zero”, if no further station information blocks 510a′-n′ are contained within the respective shared AP info block 520a. In an embodiment, the respective shared AP info block 520a may further include information regarding a specific allocation of spatial streams to the stations 125a,b that are associated with the shared AP 120 and need nulling from the sharing AP 110 or any other shared AP (this may be the case for the Final Indication Frame 407 and in case of full nulling).

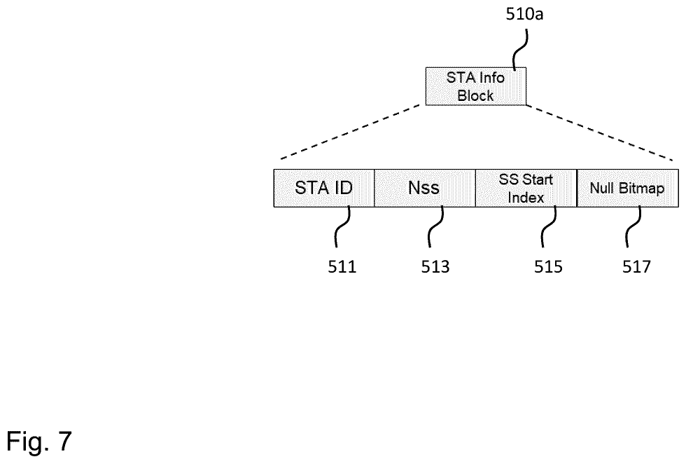

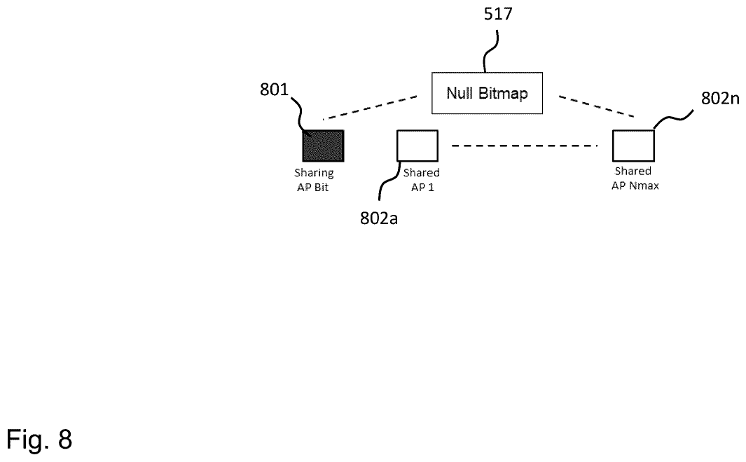

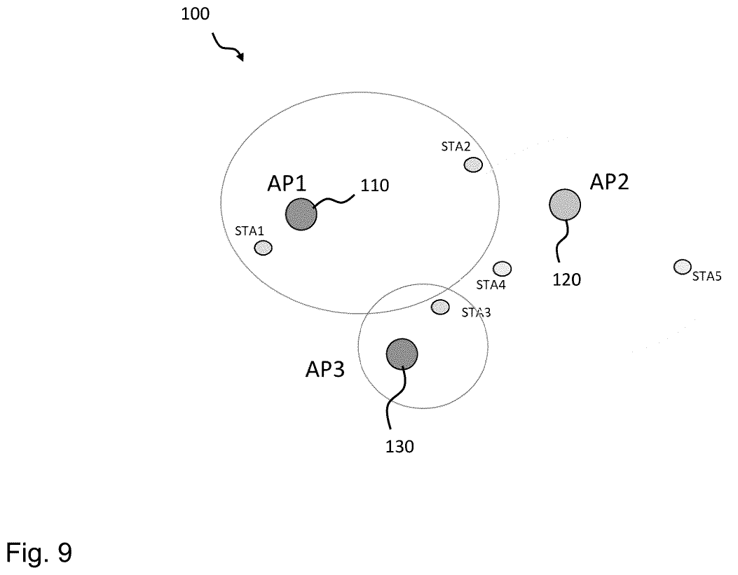

FIG. 7 shows a schematic diagram illustrating in more detail one station information block 510a of the frame 401, 407 as an example for the station information blocks 510a-n (already described above in the context of FIG. 5) for the stations 115a-c associated with the sharing AP 110 and the further station information blocks 510a′-n′ for the stations 125a,b associated with the respective shared AP 120 (already described above in the context of FIG. 6). As already described above, the station information block 510a carries information regarding a specific station that is associated with the sharing AP 110 or the shared AP(s) 120, 130 and is included in the coordinated transmission. As illustrated in FIG. 7, the station information block 510a may comprise a unique identifier (“STA ID”) 511 of the respective station (associated with the sharing AP or one of the shared APs) within the M-AP set, information (“Nss”) 513 about the number of spatial streams assigned to the respective station, an index (“SS Start Index”) 515 of the first spatial stream assigned to the respective station (which allows to obtain specific SS indices assigned to the shared AP 120, 130), and/or a nulling bitmap 517 indicative of whether nulling of the respective station associated with the sharing AP 110 is required and from which shared AP, as will be described in more detail in the following under further reference to FIGS. 8 and 9. Thus, for the exemplary embodiment shown in FIG. 1, the station information block 510a may comprise a unique identifier (“STA ID”) 511 of one of the stations, for instance, station 115a within the M-AP set, information (“Nss”) 513 about the number of spatial streams assigned to the exemplary station 115a, an index (“SS Start Index”) 515 of the first spatial stream assigned to the exemplary station 115a (which allows to obtain specific SS indices assigned to the shared AP 120, 130), and/or a nulling bitmap 517 indicative of whether nulling of the exemplary station 115a associated with the sharing AP 110 is required and from which shared AP.

FIG. 8 shows a schematic diagram illustrating in more detail an exemplary nulling bitmap 517 of the station information field 510a of FIG. 7, while FIG. 9 illustrates nulling based on a nulling bitmap in an exemplary wireless communication network according to an embodiment. As already described above, some APs may be not required to create a null towards a specific STA. The nulling bitmap 517 allows every AP 110, 120, 130 to indicate which AP is required (or not required) to create a null for this specific STA. As already described above in the context of FIG. 7, the nulling bitmap 517 is included in the station information block and refers only to the STA ID 511 indicated by the station information block 510a. Each bit 801, 802a-n of the nulling bitmap 517 corresponds to a specific AP, while the order (as defined, for instance, by the Indication frame or in a different way) is according to the order of the Shared AP Info Blocks 520a-n within the Co-BF Indication Frame 401. As illustrated in FIG. 8, a single bit 801 may be dedicated to the sharing AP 110 (may be any bit of the nulling bitmap 517). The total size, i.e. the number of bits of the nulling bitmap 517 may be the maximum number of OBSS APs that can participate in the Co-BF transmission (which is equal to the number of APs under the same coordination agreement). If the number of OBSS APs is less than the maximum number of bits, spare bits of the nulling bitmap 517 may be reserved.

In the example shown in FIG. 9, STA1 and STA2 are associated with AP1 110, STA4 and STA5 are associated with AP2 120 and STA3 is associated with AP3 130. In this illustrative example the maximum number of APs that can participate in the Co-BF transmission is set to 3 so that the size of the nulling bitmap 517 is 3 bits. As there are only three APs 110, 120, 130, two of the 5 bits of the nulling bitmap 517 may be reserved. The first bit of the nulling bitmap 517 corresponds to AP1 110, the second bit corresponds to AP2 120 and the third bit corresponds to AP3 130 (the two last bits of the nulling bitmap 517 shall be reserved). In this illustrative example a zero bit value may indicate that nulling is not required. STA1 faces interference only from AP3 130 so that the nulling bitmap 517 for STA1 will be 00100. STA2 faces interference from both AP2 120 and AP3 130 so that the nulling bitmap 517 for STA2 will be 01100. STA3 faces interference from both AP1 110 and AP2 120 so that the nulling bitmap 517 for STA3 will be 11000. STA4 faces interference from both AP1 110 and AP3 130 so that the nulling bitmap 517 for STA4 will be 10100. STA5 faces interference only from AP3 130 so that the nulling bitmap 517 for the STA5 will be 00100.

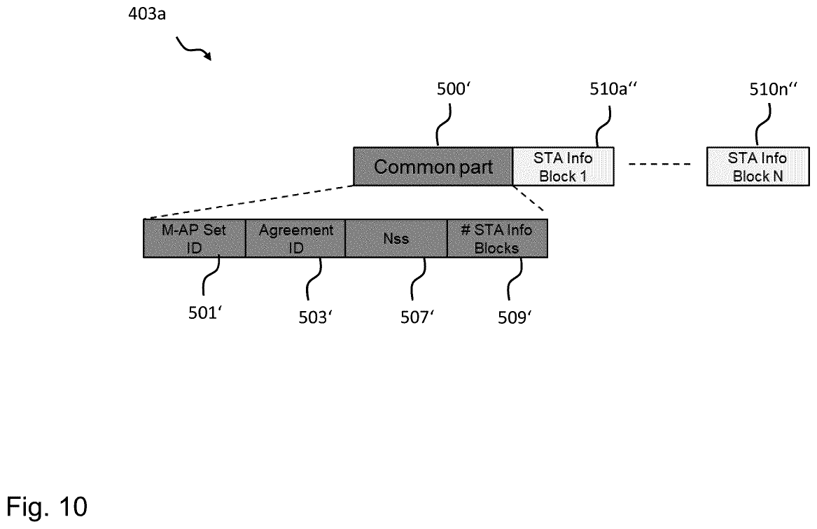

FIG. 10 shows a schematic diagram illustrating the response frame 403a, 403b transmitted by the shared AP 120, 130 according to an embodiment. The response frame 403a, 403b allows the respective shared AP 120, 130 to inform the sharing AP 110 about which spatial streams will be actually used by the shared AP 120, 130 among those assigned by the sharing AP 110 in the initial indication frame 401 (more specifically by the “Nss” field 523 of the respective Shared AP information block 520a illustrated in FIG. 6). In case of full nulling the shared AP 120, 130 may also include the information on STAs and indicate the specific allocation of spatial stream indices per STA 125a,b. More specifically, as illustrated in FIG. 10, the response frame 403a, 403b may include a common part 500′ (similarly to the common part 500 of the frame 401, 407) which may comprise information 509′ (referred to as “#STA Info Blocks” in FIG. 10) about the number of station information blocks 510a″-n″ contained within the response frame 403a, 403b and related to the stations 125a,b associated with the shared AP 120 that will actually participate in the Co-BF AP transmission. As already mentioned above, in an embodiment, the common block 500′ of the response frame 403a, 403b may further comprise information 507′ (referred to as “Nss” in FIG. 10) about the number of spatial streams that will be actually used by the shared AP 120. In an embodiment, the common block 500′ of the response frame 403a, 403b may further comprise a Multi-AP set identifier 501′ indicative of the Multi-AP set including the sharing AP 110 and the shared AP(s) 120, 130. In an embodiment, the common block 500′ of the response frame 403a, 403b may further comprise a coordination agreement identifier 503′ within the Multi-AP set.

In an embodiment, each station information block 510a″-n″ of the response frame 403a, 403b may have the same format as the station information blocks 510a-n (already described above in the context of FIG. 5) for the stations 115a-c associated with the sharing AP 110 and the further station information blocks 510a′-n′ for the stations 125a,b associated with the respective shared AP 120 (already described above in the context of FIG. 6). In other words, in an embodiment, each station information block 510a″-n″ of the response frame 403a, 403b may have the subfields illustrated in FIG. 7 and already described above to optionally include the nulling bitmap if such a null is required from the sharing AP 110 or any of the other shared APs.

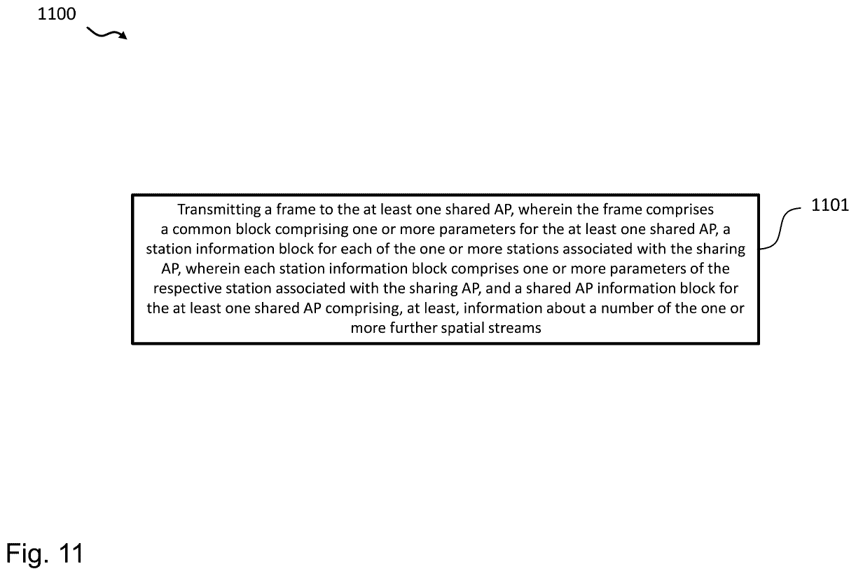

FIG. 11 is a flow diagram illustrating a method 1100 of operating the sharing AP 110 according to an embodiment. The method 1100 comprises a step of transmitting 1101 a frame 401, 407 to the at least one shared AP 120, 130, wherein the frame 401, 407 comprises a common block 500 comprising one or more parameters for the at least one shared AP 120, 130; one or more station information blocks 510a-n, wherein each station information block 510a-n includes one or more parameters of the respective station 115a-c associated with the sharing AP 110, identified within the station information block 510a-n and to be included in the coordinated AP transmission; and a shared AP information block 520a-n for the at least one shared AP 120, 130 comprising, at least, information 523 about a number of the one or more further spatial streams.

According to an embodiment, the method 1100 may comprise receiving a response frame 403a,b from the at least one shared AP 120, 130, in response to transmitting the frame 401 to the at least one shared AP 120, 130.

According to an embodiment, the method 1100 may comprise transmitting the frame 407 to the at least one shared AP 120, 130, in response to receiving the response frame 403a,b from the at least one shared AP 120, 130.

As the method 1100 can be implemented by the sharing AP 110, further features of the method 1100 result directly from the functionality of the sharing AP 110 and its different embodiments described above and below.

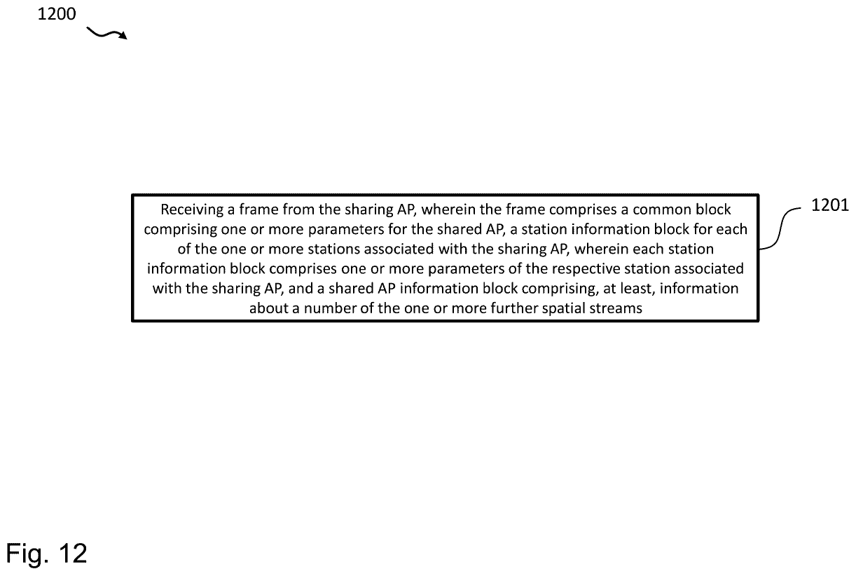

FIG. 12 is a flow diagram illustrating a method 1200 of operating the shared AP 120, 130 according to an embodiment. The method 1200 comprises a step of receiving 1201 a frame 401, 407 from the sharing AP 110, wherein the frame 401, 407 comprises a common block 500 comprising one or more parameters for the shared AP 120, 130; one or more station information blocks 510a-n, wherein each station information block includes one or more parameters of the respective station 115a-c associated with the sharing AP 110, identified within the station information block and to be included in the coordinated AP transmission; and a shared AP information block 520a-n comprising, at least, information 523 about a number of the one or more further spatial streams.

According to an embodiment, the method 1200 may further comprises transmitting a response frame 403a,b to the sharing AP 110, wherein the response frame 403a,b comprises, at least, information 507′ about an updated number of the one or more further spatial streams of the shared AP 120, 130.

According to an embodiment, the method 1200 may further comprise transmitting the response frame 403a,b to the sharing AP 110, in response to receiving the frame 401 from the sharing AP 110.

According to an embodiment, the method 1200 may further comprise receiving the frame 407 from the sharing AP 110, in response to transmitting the response frame 403a,b to the sharing AP 110.

As the method 1200 can be implemented by the shared AP 120, 130, further features of the method 1200 result directly from the functionality of the shared AP 120, 130 and its different embodiments described above and below.

The person skilled in the art will understand that the “blocks” (“units”) of the various figures (method and apparatus) represent or describe functionalities of embodiments of the present disclosure (rather than necessarily individual “units” in hardware or software) and thus describe equally functions or features of apparatus embodiments as well as method embodiments (unit=step).

In the several embodiments provided in the present application, it should be understood that the disclosed system, apparatus, and method may be implemented in other manners. For example, the described embodiment of an apparatus is merely exemplary. For example, the unit division is merely logical function division and may be another division in an actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected according to actual needs to achieve the objectives of the solutions of the embodiments.

In addition, functional units in the embodiments disclosed herein may be integrated into one processing unit, or each of the units may exist alone physically, or two or more units are integrated into one unit.

1. A sharing access point, AP, (110) configured to share at least a portion of a transmission opportunity, TXOP, with at least one shared AP (120, 130) within a Multi-AP set for participating in a coordinated transmission, the sharing AP (110) configured to communicate with one or more stations (115a-c) associated with the sharing AP (110) via one or more spatial streams and the shared AP (120, 130) configured to communicate with one or more stations (125a,b) associated with the shared AP (120, 130) via one or more further spatial streams, wherein the sharing AP (110) comprises:
a communication interface (113) configured to transmit a frame (401, 407) to the at least one shared AP (120, 130), wherein the frame (401, 407) comprises:
a common block (500), comprising one or more parameters for the at least one shared AP;
one or more station information blocks (510a-n), wherein each station information block (510a-n) includes one or more parameters of the respective station (115a-c) associated with the sharing AP (110); and
a shared AP information block (520a-n) for the at least one shared AP (120, 130) comprising, at least, information (523) about a number of the one or more further spatial streams.

2. The sharing AP (110) of claim 1, wherein the sharing AP (110) further comprises a processing circuitry (111) configured to assign the one or more spatial streams to the one or more stations (115a-c) associated with the sharing AP (110).

3. The sharing AP (110) of claim 2, wherein the processing circuitry (111) is further configured to assign the one or more further spatial streams to the at least one shared AP (120, 130).

4. The sharing AP (110) of claim 1, wherein the common block (500) of the frame (401,

407. comprises information (507) about a number of the station information blocks (510a-n) contained within the frame (401, 407).

5. The sharing AP (110) of claim 1, wherein the common block (500) of the frame (401, 407) comprises information (509) about a number of the at least one shared AP information block (520a-n) contained within the frame (401, 407).

6. The sharing AP (110) of claim 1, wherein the common block (500) of the frame (401, 407) further comprises a Multi-AP set identifier (501).

7. The sharing AP (110) of claim 1, wherein the common block (500) of the frame (401, 407) further comprises a coordination agreement identifier (503) within the Multi-AP set, wherein the coordination agreement identifier (503) identifies one coordination agreement of a plurality of coordination agreements within the Multi-AP set and wherein the sharing AP (110) and the shared AP (120, 130) both operate under the coordination agreement identified by the coordination agreement identifier within the Multi-AP set.

8. The sharing AP (110) of claim 1, wherein the common block (500) of the frame (401, 407) further comprises a response type indicator (505) indicative of a response type to be used by the shared AP (120, 130) for responding to the frame (401, 407).

9. The sharing AP (110) of claim 1, wherein the one or more parameters included in the respective station information block (510a-n) comprise information (513) about a number of the spatial streams of the one or more spatial streams assigned to the respective station (115a-c) associated with the sharing AP (110).

10. The sharing AP (110) of claim 1, wherein the one or more parameters included in the respective station information block (510a-n) comprise an identifier (511) of the respective station (115a-c) associated with the sharing AP (110).

11. The sharing AP (110) of claim 1, wherein the one or more parameters included in the respective station information block (510) comprise information (515) about a first spatial stream index of the spatial streams of the one or more spatial streams assigned to the respective station (115a-c) associated with the sharing AP (110).

12. The sharing AP (110) of claim 1, wherein the one or more parameters included in the respective station information block (510) comprise nulling information (517) for enabling the shared AP (120, 130) to determine whether nulling of a transmission signal towards the respective station (115a-c) associated with the sharing AP (110) is required for the coordinated transmission.

13. The sharing AP (110) of claim 1, wherein the shared AP information block (520) further comprises an identifier (521) of the shared AP (120, 130) within the Multi-AP set.

14. The sharing AP (110) of claim 1, wherein the shared AP information block (520) further comprises information (525) about a first spatial stream index of the further set of spatial streams.

15. The sharing AP (110) of claim 1, wherein the shared AP information block (520) further comprises one or more further station information blocks (510a′-n′), wherein each further station information block (510a′-n′) includes one or more parameters of the respective station (125a,b) associated with the shared AP (120, 130).

16. The sharing AP (110) of claim 15, wherein the shared AP information block (520) further comprises information (523) about a number of the further station information blocks (510a′-n′) included in the shared AP information block (520).

17. The sharing AP (110) of claim 15, wherein the one or more further station information blocks (510a′-n′) and the one or more station information blocks (510a-n) have the same format.

18. The sharing AP (110) of claim 15, wherein the one or more parameters included in the respective further station information block (510a′-n′) comprise information (513) about a number of spatial streams of the one or more further spatial streams assigned to the respective station (125a,b) associated with the shared AP (120, 130) and included in the coordinated transmission.

19. The sharing AP (110) of claim 15, wherein the one or more parameters included in the respective further station information block (510a′-n′) comprise an identifier (511) of the respective station (125a,b) associated with the shared AP (120, 130).

20. The sharing AP (110) of claim 15, wherein the one or more parameters included in the respective further station information block (510a′-n′) comprise information (515) about a first spatial stream index of the spatial streams of the one or more further spatial streams assigned to the respective station (125a,b) associated with the shared AP (120, 130).
